(19) United States
(12) Patent Application Publication
(10) Pub. No.: US 2020/0129381 A1
(43) Pub. Date: Apr. 30, 2020

(54) DOUBLE LUMEN NEONATAL FEEDING TUBE

(71) Applicant: Green Sand Neonatal Solutions LLC, Dallas, TX (US)

(72) Inventors: Maria R. Sandoval, Arlington, TX (US); David W. Green, Dallas, TX (US)

(73) Assignee: Green Sand Neonatal Solutions LLC, Dallas, TX (US)

(21) Appl. No.: 16/168,899

(22) Filed: Oct. 24, 2018

(51) Int. Cl. A61J 15/00

(52) U.S. Cl. CPC A61J 15/0003; A61J 15/0096; A61J 15/0073

(57) ABSTRACT

An improved double lumen neonatal feeding tube has a dedicated feeding lumen coupled to a dedicated venting lumen, together forming a single tube. The feeding lumen has one or more feeding holes and the venting lumen has multiple venting holes at a position higher on the tube than the feeding holes. The inclusion of a dedicated venting lumen allows for constant venting even during times when the feeding lumen is in use for feeding.

The present disclosure pertains to a neonatal feeding tube having a double lumen and permitting the simultaneous functions of feeding and gas venting.

### BACKGROUND

Of the 4 million newborns delivered in the US each year, approximately 400,000 will require some degree of neonatal intensive care. The length of stay in the neonatal intensive care unit (NICU) for these newborns ranges from hours to months, and varies according to the degree of prematurity, extent of other pathologies, associated malformations, and other complicating factors. The current national average NICU length of stay is around 14 days.

One of the most common problems these newborns face is that of respiratory distress.

Newborn respiratory distress may be caused by various factors, singular or in combination; common causes include prematurity, infection, and some type of amniotic fluid aspiration. Respiratory support for these infants range from “non-invasive” means such as an oxygen hood, nasal cannula, high-flow nasal cannula (HFNC), and nasal continuous positive airway pressure (NCPAP), to “invasive” endotracheal mechanical ventilation.

Recent evidence has steered neonatal clinicians to replace invasive respiratory support with as much non-invasive support as clinically feasible. This “kinder, gentler” approach to neonatal respiratory support results in less short-term lung injury and improved long-term pulmonary and neurodevelopmental outcomes. In response to these findings, NCPAP and HFNC have replaced mechanical ventilation as the major modes for the delivery of respiratory support in many NICUs. While pulmonary outcomes have improved, the use of NCPAP/HFNC has come with some potentially troublesome side effects. These include nasal trauma, pneumothorax, and gastrointestinal (GI) distension (due to excessive air swallowing or aerophagia) with its resultant feeding intolerance. While the learning curve has minimized several of these unwanted side-effects, gastrointestinal distension remains a vexing problem for caregivers managing neonates on NCPAP/HFNC.

A second problem many ill newborns face is related to their nutrition. Adequate nutrition is crucial for healing, as well as proper development of the newborn brain. An important collateral complication of neonatal respiratory distress and its causes is the prevention of the baby to take feedings by mouth. Until able to feed orally, these infants are nourished by some combination of intravenous and gastric tube feedings, with the ultimate goal of all oral feedings. Flexible gastric feeding tubes, inserted into the stomach via the nose or mouth, are initially used to provide a simple, safe way to deliver the maximum amount of nutrition until these infants have recovered to take adequate feedings by mouth. Not unexpectedly, many of these ill babies have trouble tolerating even small amounts of enteral feedings due to their degree of illness. Feeding intolerance limits enteral nutrition delivery, which in turn can slow healing, increase infection rates, and subsequently negatively impact hospital course, length of stay, and long-term outcomes.

Achieving the simultaneous goals of providing non-invasive respiratory support, while maximizing nutrition, is often challenging in the neonatal population. These areas of care are in fact intrinsically related and may result in significant, deleterious interference with one another. Specifically, respiratory support may negatively impact feeding tolerance/delivery due to its resultant patient agitation, GI distension, and hormonal alterations. These complications are compounded by the fact that nearly all sick newborns (especially those that are premature) have various degrees of inherent gastro-intestinal dysfunction. Alternatively, the delivery of adequate enteral nutrition, while necessary for growth and development, may impact negatively on various aspects of respiratory support.

To illustrate these challenges, consider the previously noted gastrointestinal distension seen commonly with NCPAP/HFNC. The accumulation of CPAP-derived gas in the GI tract is so common it has been come to be known as “CPAP-belly.” While intubated, neonates theoretically have gas delivered mainly to the lungs. On the other hand, NCPAP/HFNC deliver continuous gas flow through the nasopharynx; this gas can enter both the lungs and the GI tract. While this flow assists gas exchange in the lungs, the undesired delivery and accumulation of gas in the GI tract may result in significant GI distension. Unchecked, progressive accumulation of air in the gut may result in more respiratory distress (by pushing up on the diaphragm), which in turn may result in escalation of respiratory support, and often ultimately affect the success of the delivery of adequate enteral nutrition.

Current standard management of babies on NCPAP includes the use of a single lumen gastric feeding tube which functions as both a route for enteral nutrition, as well as a route to allow venting of excessive gastrointestinal gas. When feedings are not running through the gastric tube, it can be opened (“vented”) to help allow egress of gastric air and thus (hopefully) limit the accumulation of unwanted, excessive gastrointestinal gas. This technique becomes a problem when the gastric tube vent time does not keep up with gastric gas accumulation, resulting in CPAP belly. In addition, gastric contents may block the lower holes in the feeding tube, preventing the effective venting of gas. Further complicating matters, smaller sicker babies may require feedings slowly delivered over time, thus lessening the time period that the gastric tube is available to function as a vent, and increasing the time for gas accumulation. Simply put, the limitation of a single lumen gastric tube is its inability to perform both enteral feeding and gastric venting simultaneously. This can become a serious shortcoming when caring for a baby on NCPAP/HFNC.

In some infants, unrelenting abdominal distension on NCPAP/HFNC leads caregivers to try the use of 2 separate gastric tubes—one to provide nutrition and one to vent the stomach. While this technique is effective in some cases, it is fraught with issues of maintaining the proper position, alignment, and function of both tubes. In some infants, unchecked CPAP belly/distension may lead to endotracheal intubation in a final attempt to limit aerophagia and improve feeding tolerance/nutrition.

Existing single lumen nasogastric feeding tubes have an opening at the lowermost tip, and usually 1-2 other openings very near the lowermost tip. This lumen either carries feedings down into the stomach, or when feedings are off, gas up and out of the stomach. This either/or proposition is problematic when required feeding time impinges on gas vent time; this mismatch in venting time may result in excessive gastrointestinal gas accumulation and its related problems.

An additional group of nasogastric tubes function purely to provide nasogastric venting. This type of tube is used in instances when gastro-intestinal peristalsis is impaired (ileus), as seen in surgical patients. Known as a “replogle” type tube, it is stiffer and has thicker walls (to prevent collapse) than the typical feeding tube. This is due to the need for the application of active suction (i.e. negative pressure that would collapse the wall of a thinner, non-reinforced tube). These tubes may also have a second “flush” lumen that connects to the upper part of the suction lumen, to allow flushing of debris from the suction lumen to prevent obstruction with gastrointestinal debris. By design, this replogle tube is stiffer than a routine feeding tube so that it performs with an active negative pressure application. While a necessary neonatal tool, the replogle tube comes with well-known, inherent risks due to its composition. Stiffer, less modern plastics result in a much higher risk of gastric perforation in this fragile population. In addition, it is not formatted to deliver nutrition but rather only the removal of gastrointestinal contents. These factors also contribute to each individual tube's short lifetime of use (hours to days) in each patient.

### SUMMARY

The present disclosure relates to an improved neonatal gastric feeding tube. The improved neonatal feeding tube is a double lumen tube with separate lumens to provide separate routes for the simultaneous actions of gastric feeding and gas venting. This unique, specialized gastric tube can deliver up to continuous enteral nutrition via a feeding lumen, while simultaneously allowing for continuous gastric venting via side holes of a second venting lumen.

The functional goals of the double lumen feeding tube are intricately related and synergistic. The beneficial combination of minimizing the gastrointestinal and pulmonary side effects of excessive gastrointestinal gas, paired with improved delivery of enteral nutrition, is expected to improve overall patient care management and health, and thus theoretically speed the patient's overall recovery. Research is clear that maximizing enteral nutrition is important in the promotion of healing and growth potential for these infants, as well as improving long-term growth and development.

It is clear that the gastric feeding tube is an indispensable tool for improving the long-term outcome in intensive care neonates. The delivery of enteral nutrition, while simultaneously venting the stomach, by a single gastric tube, is unique to modern NICU care. The dual, simultaneous capabilities of feeding and venting represent a significant upgrade to the current single lumen system. The anticipated improvements in short-term outcomes and length of hospital length of stay, coupled with improved long-term outcomes, are the ultimate dyad of continually sought goals of all dedicated providers of modern neonatal intensive care.

### BRIEF DESCRIPTION OF DRAWINGS

FIG. 1 shows a double lumen feeding tube, in accordance with preferred embodiments described herein.

FIG. 2 shows an enlarged cross-sectional view of a double lumen feeding tube, in accordance with preferred embodiments described herein.

FIG. 3 shows an enlarged cross-sectional view of a double lumen feeding tube, in accordance with additional preferred embodiments described herein.

FIG. 4 shows a perspective view of a lowermost end of a double lumen feeding tube, in accordance with preferred embodiments described herein.

FIG. 5 shows a side view of a lowermost end of a double lumen feeding tube, in accordance with preferred embodiments described herein.

FIG. 6 shows an alternate side view of a lowermost end of a double lumen feeding tube, in accordance with preferred embodiments described herein.

FIG. 7 shows a side view of a lowermost end of a double lumen feeding tube, in accordance with preferred embodiments described herein.

FIG. 8 shows a front view of a portion of a double lumen feeding tube with a feeding adapter, in accordance with preferred embodiments described herein.

FIG. 9 shows a front view of a portion of a double lumen feeding tube with a venting adapter, in accordance with preferred embodiments described herein.

FIG. 10 shows a front view of a portion of a double lumen feeding tube with both a feeding adapter and a venting adapter, in accordance with preferred embodiments described herein.

### DETAILED DESCRIPTION OF PREFERRED EMBODIMENTS

The present disclosure relates to a double lumen neonatal feeding tube having a dedicated feeding lumen coupled to a dedicated venting lumen, together forming a single tube. In preferred embodiment, the double lumen feeding tube is made of modern soft plastic and has a tube diameter that is not significantly larger than current single lumen feeding tubes. The feeding lumen has a hole at the tip and at least one additional hole on the side of the feeding lumen in close proximity to the tip. The venting lumen terminates at a position inside the tube that does not reach the tip of the feeding lumen and has at least three staggered side holes relatively close to its termination point. The holes in the venting lumen extend higher on the tube than the holes in the feeding lumen in order to avoid interfering with feedings and provide additional ports for venting.

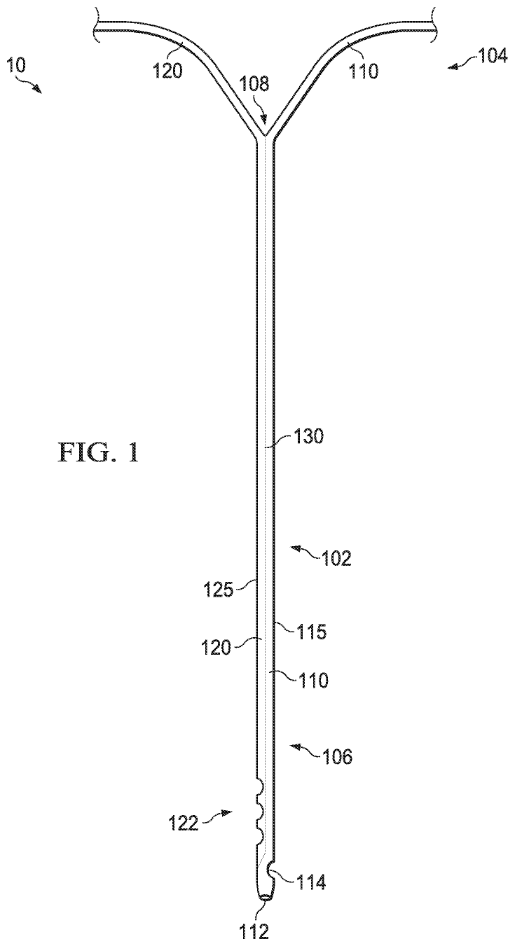

FIG. 1 shows a double lumen feeding tube 10, in accordance with preferred embodiments described herein. In this embodiment, the double lumen feeding tube 10 includes an upper separated portion 104, a branch point 108, and a connected portion 102 that is made up of two separate lumens—a feeding lumen 110 and a venting lumen 120. Feeding lumen 110 includes an outer feeding lumen wall 115 and venting lumen 120 includes an outer venting lumen wall 125. Feeding lumen 110 is separated from venting lumen 120 inside the connected portion 102 by central wall 130. The connected portion 102 generally has a lower portion 106. In the lower portion 106, it is seen that central wall 130 preferably does not extend to the lowermost tip of the combined tube portion 102. Accordingly, venting lumen 120 is preferably shorter than feeding lumen 110. In certain preferred embodiments, feeding lumen 110 extends for an additional 1-2 cm past a lowermost end of venting lumen 120. Also in the lower portion 106 of the combined tube portion 102, feeding lumen 110 includes a first feeding hole 112 positioned at the lowermost tip of the connected portion 102 as well as at least one secondary feeding hole 114 positioned in outer feeding lumen wall 115 and close in proximity to the first feeding hole 112. Alternate embodiments may include additional secondary feeding holes and secondary feeding holes in different locations. These secondary feeding holes can be placed in the lower 1-2 cm of feeding lumen 110, preferably in the lower 1 cm of feeding lumen 110. Feeding holes are preferably about 2-3 mm in diameter. The size, number, and placement of the feeding holes can vary depending on the application of the double lumen feeding tube. Larger babies having larger stomachs may accommodate larger feeding holes and a greater number of feeding holes. First feeding hole 112 can be the same size or a different size compared to the at least one secondary feeding hole 114.

Also shown in FIG. 1, venting lumen 120 includes, in preferred embodiments, at least three venting holes 122 positioned in outer venting lumen wall 125 and in the lower portion 106 of the connected portion 102. Preferably, all venting holes 122 are placed in the outer venting lumen wall 125 at positions that are higher, or closer to the branch point 108, than secondary feeding hole 114. This placement helps the venting holes 122 avoid interfering with feeding delivery and function effectively. In preferred embodiments, the lowest venting hole is about 1 cm above the lowermost tip of the connected portion 102. Alternate embodiments may include more than three venting holes. Additional alternate embodiments may utilize venting holes that are in staggered locations. In preferred embodiments, all venting holes are placed in the lower 2-4 cm, and preferably the lower 2.5 cm, of double lumen feeding tube 10, or within the lower 1-3 cm, and preferably the lower 1.5 cm, of venting lumen 120. Venting holes are preferably about 3-4 mm in diameter. The size, number and placement of the venting holes can vary depending on the application of the double lumen feeding tube. Larger babies having larger stomachs may accommodate larger venting holes and greater number of venting holes.

FIG. 1 also shows that above branch point 108 and in upper separated portion 104, feeding lumen 110 is separated from venting lumen 120. The individual feeding lumen 110 and venting lumen 120 can then be treated separately in accordance with their intended functions. In use, branch point 108 should be at a position where it does not enter the nasal or oral cavity of the patient, ensuring that only the connected portion 102 requires placement in the patient. The length of double lumen feeding tube 10 from its lowermost end in connected portion 102 to the branch point 108 can vary depending on the application and the size of the patient, but is preferably about 30 cm for smaller babies and 40 cm for bigger babies. In practice the uppermost end of feeding lumen 110 above branch point 108, which is typically about 10 cm, would be connected with a syringe or other device for providing food to the patient. When food is not being provided, the uppermost end of feeding lumen 110 could also be left open for venting. The uppermost end of venting lumen 120 above branch point 108 would typically remain open to allow for venting in a continuous fashion, even during feeding.

In preferred embodiments, the double lumen feeding tube has an overall size of about 8 to 9 Fr, or a circumference of about 8.3 mm to about 9.4 mm. Within the double lumen feeding tube, in certain embodiments, the feeding lumen may have a size of about 4 to 6 Fr, or a circumference of about 4.2 to about 6.3 mm. In additional preferred embodiments, the feeding lumen has a size of about 5 Fr, or a circumference of about 5.2 mm. In certain embodiments, the venting lumen has a size of about 5 to 7 Fr, or a circumference of about 5.2 to about 7.3 mm. In additional preferred embodiments, the venting lumen has a size of about 6 Fr, or a circumference of about 6.3 mm. Because the feeding lumen and the venting lumen share a central wall, their combined circumference is less than their individual circumferences added together.

The double lumen feeding tube is preferably constructed of a soft, flexible plastic such as polymeric silicone (such as SILASTIC®, Dow Corning, Midland, Mich.), polyurethane, silicone rubber, nylon, polyethylene terephthalate, latex, or combinations thereof. For ease of assembly, it is preferred that the double lumen feeding tube be constructed of a single type of material. However, certain embodiments may include the use of a stiffer, less flexible plastic for the venting lumen portion of the double lumen feeding tube. This will accommodate the potential use of negative pressure, similar to a replogle tube, on the venting side of the double lumen tube.

In certain additional embodiments, the double lumen feeding tube is printed with markings, including but not limited to measurement lines for placing the tube at a correct depth in a patient and/or suitable symbols, letters or labels to identify which lumen is for feeding and which lumen is for venting. In certain additional embodiments, the double lumen feeding tube further comprises one or more radi-opaque markings or lines which will be visible on a radiograph (X-ray).

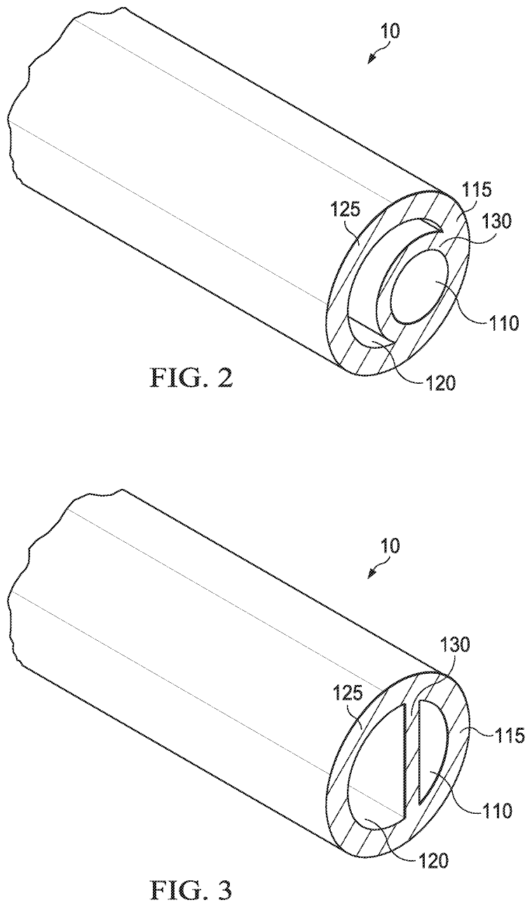

FIG. 2 shows an enlarged cross-sectional view of double lumen feeding tube 10, in accordance with preferred embodiments. In this preferred embodiment, feeding lumen 110 has a generally circular cross-section, while venting lumen 120 has a generally crescent shaped cross-section. In this embodiment, central wall 130 separates feeding lumen 110 from venting lumen 120 and forms what is essentially a “tube within a tube” structure. Outer feeding lumen wall 115 together with outer venting lumen wall 125 make up the overall outer circumference of double lumen feeding tube 10. In this preferred embodiment, central wall 130 is not as thick as outer feeding lumen wall 115 and outer venting lumen wall 125. In preferred embodiments, outer feeding lumen wall 115 and outer venting lumen wall 125 may have a thickness of about 0.45 mm and central wall 130 may have a thickness of 0.30 mm. The relative thickness of central wall 130 and the outer walls can vary depending on the application and the material used to construct double lumen feeding tube 10. Similarly, above the branch point where the lumens are separated, each lumen may have a different wall thickness.

FIG. 3 shows an enlarged cross-sectional view of double lumen feeding tube 10, in accordance with additional preferred embodiments. In this preferred embodiment, central wall 130 essentially divides asymmetrically the overall outer circumference of double lumen feeding tube 10, separating feeding lumen 110 from venting lumen 120. Outer feeding lumen wall 115 together with outer venting lumen wall 125 continue to make up the overall outer circumference of double lumen feeding tube 10. Relative thicknesses of the walls can be similar to those discussed for FIG. 2 and again can vary based on application and the material used to construct double lumen feeding tube 10.

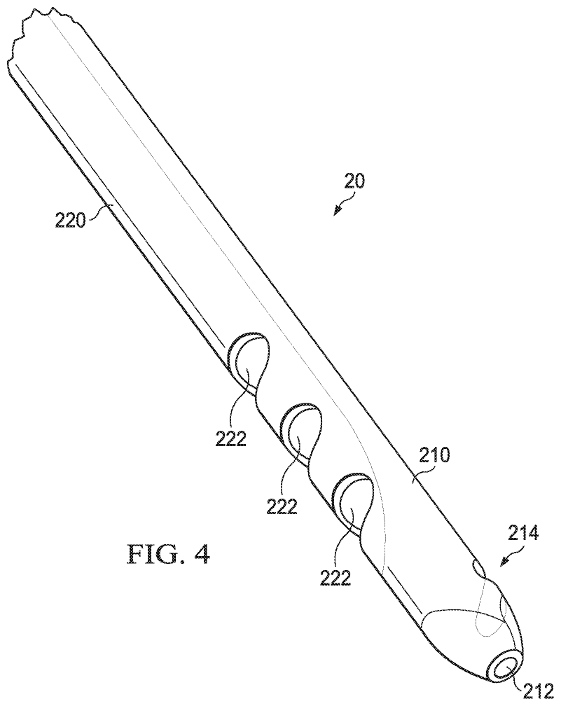

FIG. 4 shows a perspective view of a lowermost end of an alternate embodiment of a double lumen feeding tube 20. Feeding lumen 210 includes a first feeding hole 212 at a lowermost tip of the double lumen feeding tube 20 and a secondary feeding hole 214 at a position slightly higher, or closer to the branch point (not shown), in feeding lumen 210. It is seen in FIG. 4 that the lowermost end of double feeding tube 20 is generally tapered, terminating in first feeding hole 212. Venting lumen 220 is shown at a position terminating above the lowermost end of double lumen feeding tube 20. Venting lumen 220 includes three venting holes 222 of equal size and parallel placement, in this particular embodiment.

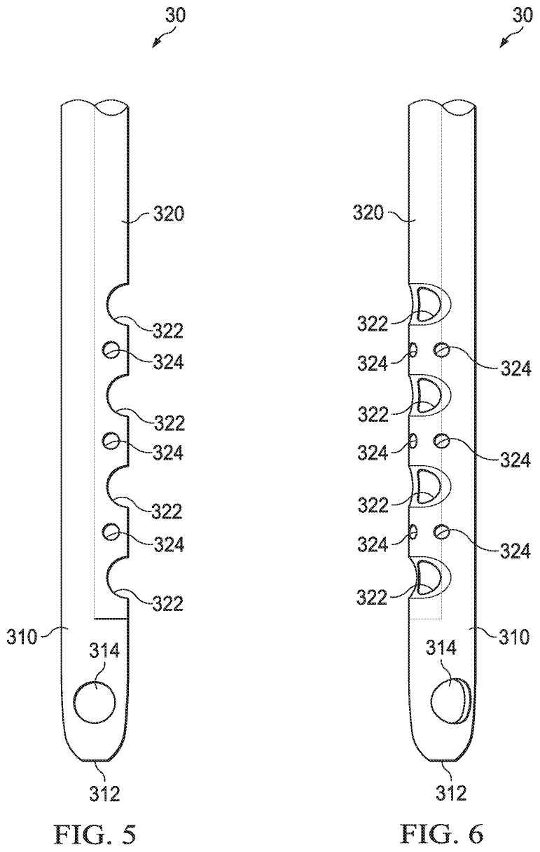

FIG. 5 shows a side view of a lowermost end of an alternate embodiment of a double lumen feeding tube 30. Feeding lumen 310 includes a first feeding hole 312 at a lowermost tip of the double lumen feeding tube 30 and a secondary feeding hole 314 at a position slightly higher, or closer to the branch point (not shown), on double lumen feeding tube 30. Venting lumen 320 terminates at a higher position on double lumen feeding tube 30. Venting lumen 320 includes four primary venting holes 322 and three secondary venting holes 324 in alternating order, positioned at different locations on venting lumen 320.

FIG. 6 shows an alternate side view of a lowermost end of an embodiment of a double lumen feeding tube 30, similar to what is shown in FIG. 5. Feeding lumen 310 includes a first feeding hole 312 at a lowermost tip of the double lumen feeding tube 30 and a secondary feeding hole 314 at a position slightly higher, or closer to the branch point (not shown), on double lumen feeding tube 30. Venting lumen 320 terminates at a higher position on double lumen feeding tube 30. Venting lumen 320 includes four primary venting holes 322. In this view, it is seen that there are six secondary venting holes 324 interspersed with the primary venting holes 322 at different locations on venting lumen 320.

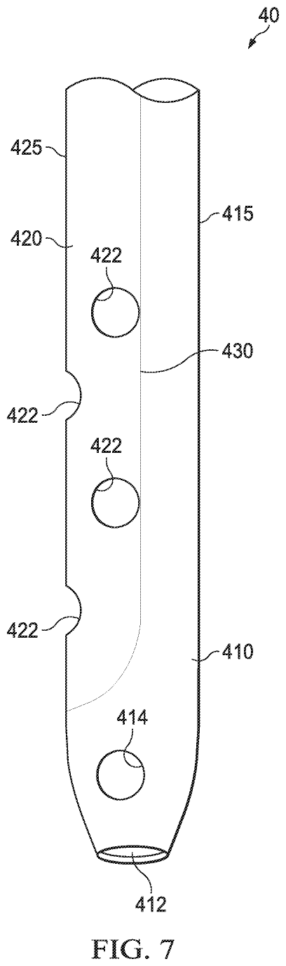

FIG. 7 shows a side view of a lowermost end of an alternate embodiment of a double lumen feeding tube 40. In this embodiment, feeding lumen 410 includes a first feeding hole 412 and a secondary feeding hole 414 at positions in outer feeding lumen wall 415. Venting lumen 420 includes four venting holes 422 at staggered locations on outer venting lumen wall 425. Central wall 430 separates feeding lumen 410 and venting lumen 420.

FIG. 8 shows a front view of an upper separated portion 504 of an alternate embodiment of a double lumen feeding tube 50. In this embodiment, double lumen feeding tube 50 has a feeding lumen 510 and a venting lumen 520 that are separate above branch point 508. Venting lumen 520 has a venting lumen upper end 521 that can be attached to any suitable venting connector. In this embodiment, feeding lumen 510 is attached to a feeding adapter 511 which can be used to inject or provide milk, formula, or other liquid nutrition into feeding lumen 510.

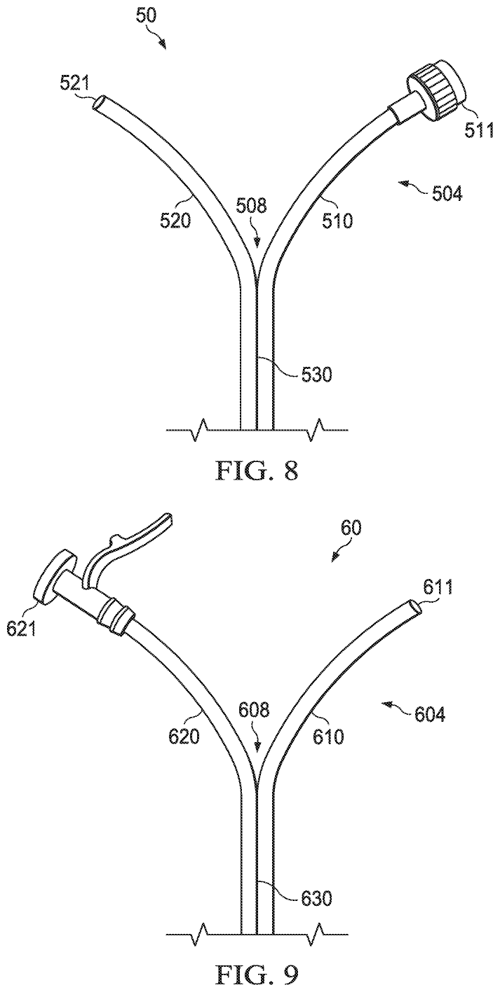

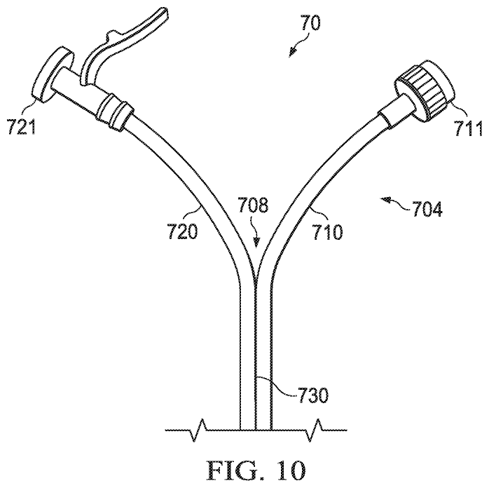

FIG. 9 shows a front view of an upper separated portion 604 of an alternate embodiment of a double lumen feeding tube 60. In this embodiment, double lumen feeding tube 60 has a feeding lumen 610 and a venting lumen 620 that are separate above branch point 608. In this embodiment, venting lumen 620 is attached to a venting adapter 621 which can be used in conjunction with a syringe or any other device to assist with venting. Any suitable feeding or venting connectors or adapters, including but not limited to those shown in FIG. 8 and FIG. 9, can be matched and fitted on the appropriate lumen—feeding, venting, or both—to facilitate the administration of food or other liquids and/or to assist with venting. The feeding and venting connectors or adapters may be the same or different types of adapters. FIG. 10 shows a front view of an upper separated portion 704 of an alternate embodiment of a double lumen feeding tube 70. In this embodiment, double lumen feeding tube 70 has a feeding lumen 710 and a venting lumen 720 that are separate above branch point 708. In this embodiment, venting lumen 720 is attached to a venting adapter 721 which can be used in conjunction with a syringe or any other device to assist with venting and feeding lumen 710 is attached to a feeding adapter 711 which can be used to inject or provide milk, formula, or other liquid nutrition into feeding lumen 710.

What is claimed is:

1. A double lumen feeding tube having an upper separated portion, a branch point, and a connected portion having a lowermost tip, comprising:
a feeding lumen having an outer feeding lumen wall located in the connected portion of the double lumen feeding tube, wherein a first feeding hole is located at the lowermost tip of the connected portion and one or more secondary feeding holes are located on the outer feeding lumen wall in proximity to the first feeding hole;
a venting lumen connected to and extending parallel to the feeding lumen in the connected portion of the double lumen feeding tube, wherein the venting lumen has an outer venting lumen wall and a lowermost end, wherein the feeding lumen and the venting lumen are separated by a central wall in the connected portion of the double lumen feeding tube, wherein the lowermost end of the venting lumen is located at a position above the lowermost tip of the connected portion, wherein a plurality of venting holes are located on the outer venting lumen wall in proximity to the lowermost end of the venting lumen, wherein the outer feeding lumen wall and the outer venting lumen wall connect to form an outer circumference of the connected portion of the double lumen feeding tube, and wherein the feeding lumen and the venting lumen are separated above the branch point in the upper separated portion of the double lumen feeding tube.

2. The double lumen feeding tube of claim 1, wherein the plurality of venting holes comprises at least three venting holes.

3. The double lumen feeding tube of claim 1, wherein the double lumen feeding tube comprises polymeric silicone, polyurethane, silicone rubber, nylon, polyethylene terephthalate, latex, or combinations thereof.

4. The double lumen feeding tube of claim 1, wherein the connected portion has a size of about 8 Fr to about 9 Fr, the feeding lumen has a size of about 4 to 6 Fr, and the venting lumen has a size of about 5 to 7 Fr.

5. The double lumen feeding tube of claim 1, wherein the connected portion has an outer circumference of about 8.3 mm to about 9.4 mm.

6. The double lumen feeding tube of claim 1, wherein the lowermost end of the venting lumen is a distance of about 1 to 2 cm from the lowermost tip of the connected portion.

7. The double lumen feeding tube of claim 1, wherein all venting holes are located within a distance of about 2 to about 4 cm from the lowermost tip of the connected portion.

8. The double lumen feeding tube of claim 1, wherein all venting holes are located at a distance greater than about 1 cm from the lowermost tip of the connected portion.

9. The double lumen feeding tube of claim 1, wherein the feeding lumen further comprises a feeding adapter located above the branch point in the upper separated portion of the double lumen feeding tube.

10. The double lumen feeding tube of claim 1, herein the venting lumen further comprises a venting adapter located above the branch point in the upper separate portion of the double lumen feeding tube.

11. A method of providing nutrition to a patient through a feeding tube while simultaneously venting gas from the patient's stomach, comprising:
inserting the double lumen feeding tube of claim 1 through a nasal or oral cavity of the patient until the lowermost tip of the connected portion reaches the patient's stomach;
providing nutrition through the feeding lumen of the double lumen feeding tube; and
allowing the venting lumen to facilitate removal of gases from the patient's stomach during the step of providing nutrition through the feeding lumen.
